(19) United States
(12) Patent Application Publication
(10) Pub. No.: US 2015/0232313 A1
(43) Pub. Date: Aug. 20, 2015

(54) KIT AND METHOD FOR EXTENDING A STOCK SUPPORTING LEG OF A TRAILER TONGUE JACK

(71) Applicant: Stalwart Design & Development LLC, Elkhart, IN (US)

(72) Inventors: Robert F. Mater, JR., Elkhart, IN (US); Auldreg R. Dismuke, Elkhart, IN (US)

(21) Appl. No.: 14/600,347

(22) Filed: Jan. 20, 2015

Related U.S. Application Data
(60) Provisional application No. 61/929,281, filed on Jan. 20, 2014.

(51) Int. Cl. B66F 13/00; B60S 9/02

(52) U.S. Cl. CPC B66F 13/00; B60S 9/02

(57) ABSTRACT

A kit is provided for extending a stock support leg of a trailer jack and thereby allowing an increased range of height adjustment of the trailer jack end of the trailer. That kit includes a spacer that is received over a portion of the stock support leg of the trailer and an extension support leg that is received over the spacer.

This application claims the benefit of U.S. Provisional Patent Application Ser. No. 61/929,281, filed on Jan. 20, 2014, the disclosure of which is incorporated herein by reference.

### TECHNICAL FIELD

This document relates generally to the trailer accessory field and, more particularly, to a kit and method for extending a stock support leg of a trailer tongue jack, thereby (a) increasing the height adjustment range of the trailer jack and (b) allowing one to raise the trailer jack end of the trailer to a greater height as necessary to (1) better level a trailer on uneven ground, (2) raise the trailer hitch coupler to engage a tow ball on a taller vehicle or (3) reduce the effort, time and number of crank rotations required to achieve a level trailer position to safely un-hook or re-hook the trailer with the tow vehicle.

### BACKGROUND

As illustrated in FIG. 1, trailers T generally come equipped with an OEM trailer tongue jack J. More specifically, trailer jack J includes a stock support leg L having an outer tube O and an inner tube I concentrically received within the outer tube. A handle H is cranked clockwise or counterclockwise to extend or retract the telescoping inner tube I and effectively raise or lower the trailer jack end of the trailer T supported on the footpad F at the bottom end of the inner tube I. The effort and time required to raise or lower the jack is between 36 and 40 revolutions for a 6 inch adjustment.

Some OEM trailer jacks J are relatively short and compact and, therefore, allow for only limited height adjustment. Often, that height adjustment is not sufficient to allow one to level a disconnected trailer or raise the trailer hitch coupling C sufficiently above the ground to allow connection to the cooperating tow ball secured to the trailer hitch of a towing vehicle. This is particularly a problem where the trailer T is resting on a slight slope or uneven terrain with the trailer jack J on the low side of the terrain.

In order to address this issue, many trailer operators will use cut lumber, blocks of wood, bricks, or concrete blocks B or other materials to raise the trailer jack end of the trailer T further above the ground. Note, particularly, FIG. 1 showing several pieces of cut lumber/blocks of wood B positioned between the ground G and the footpad F of the trailer jack J to efficiently raise the trailer hitch coupler C. More often the trailer operator will used these blocks to reduce the time and effort required to crank the jack all the way to the required position. The arrangement and condition of these blocks vary with time and terrain and as a result, the use of these blocks is a serious potential safety hazard especially on uneven ground or when loading or unloading the trailer.

This document relates to a very simple and inexpensive kit and related method that may be utilized to extend the length of the stock support leg L of the trailer jack J and, therefore, the height of the trailer jack end of the trailer T.

### SUMMARY

In accordance with the purposes and benefits described herein, a kit is provided for extending a stock support leg of a trailer jack. That kit may be broadly described as comprising a spacer received over a portion of the stock support leg and an extension support leg received over the spacer. More specifically, the spacer is a sleeve and the portion over which the sleeve is received is the inner tube I.

Significantly, the stock support leg has a first diameter D₁, the spacer has a second diameter D₂ and the extension support leg has a third diameter D₃ where D₁<D₂<D₃ and whereby the spacer is concentrically received over the portion of the stock support leg and the extension support leg is concentrically received over the spacer.

The kit further includes a first fastener for securing the spacer to the stock support leg and a second fastener for securing the extension support leg to the stock support leg. Still more specifically, the spacer includes a first aperture that receives the first fastener and a first set of opposed mounting apertures that receive the second fastener. In one possible embodiment, the first fastener is an Allen screw having a distal end engaging the stock support leg and a proximal end contained within the first aperture.

Further describing the kit, the extension support leg includes a second set of opposed mounting apertures that are aligned with (a) the first set of opposed mounting apertures in the spacer and (b) a third set of opposed mounting apertures in the stock support leg. The second fastener extends through the first, second and third set of opposed mounting apertures. In one possible embodiment the second fastener is a clevis pin.

The extension support leg includes a plurality of the second sets of opposed mounting apertures which are spaced longitudinally along the extension support leg so as to allow for different positioning of the extension support leg on the stock support leg and height adjustment of the trailer jack.

In one possible embodiment the extension support leg is flared at the first or top end so as to be more easily received over the spacer and the stock support leg. Further, a trailer support is provided at a second end of the extension support leg. In one possible embodiment, that trailer support is a foot pad.

In accordance with an additional aspect, a method is provided of adjusting the height of a trailer jack. That method comprises the steps of: (a) positioning a spacer sleeve over an inner tube of a stock trailer jack, (b) positioning an extension support leg over the spacer sleeve on the stock trailer leg and (c) securing the extension support leg to the inner tube of the stock trailer jack. Still further, the method may include the step of adjusting the positioning of the extension support leg on the inner tube of the stock trailer jack in order to adjust the height of the stock trailer jack.

In the following description, there are shown and described several preferred embodiments of the kit and the related method. As it should be realized, the kit and method are capable of other, different embodiments and their several details are capable of modification in various, obvious aspects all without departing from the kit and method as set forth and described in the following claims. Accordingly, the drawings and descriptions should be regarded as illustrative in nature and not as restrictive.

### BRIEF DESCRIPTION OF THE DRAWING FIGURES

The accompanying drawing figures incorporated herein and forming a part of the specification, illustrate several aspects of the kit and together with the description serve to explain certain principles thereof. In the drawing figures:

FIG. 1 is a perspective view of a stock trailer jack with a foot pad resting upon several pieces of lumber or blocks of wood further raising the trailer jack end of the trailer above the ground.

FIG. 2 is an exploded perspective view of the kit utilized to extend the stock support leg of the trailer jack and increase the height adjustment range of the trailer jack.

FIGS. 3a-3c are perspective views illustrating how the kit is secured to the stock trailer jack and utilized to adjust the height of the trailer jack through an extended range.

FIG. 4 is a cross-sectional view of the kit secured to the inner tube of the stock support leg.

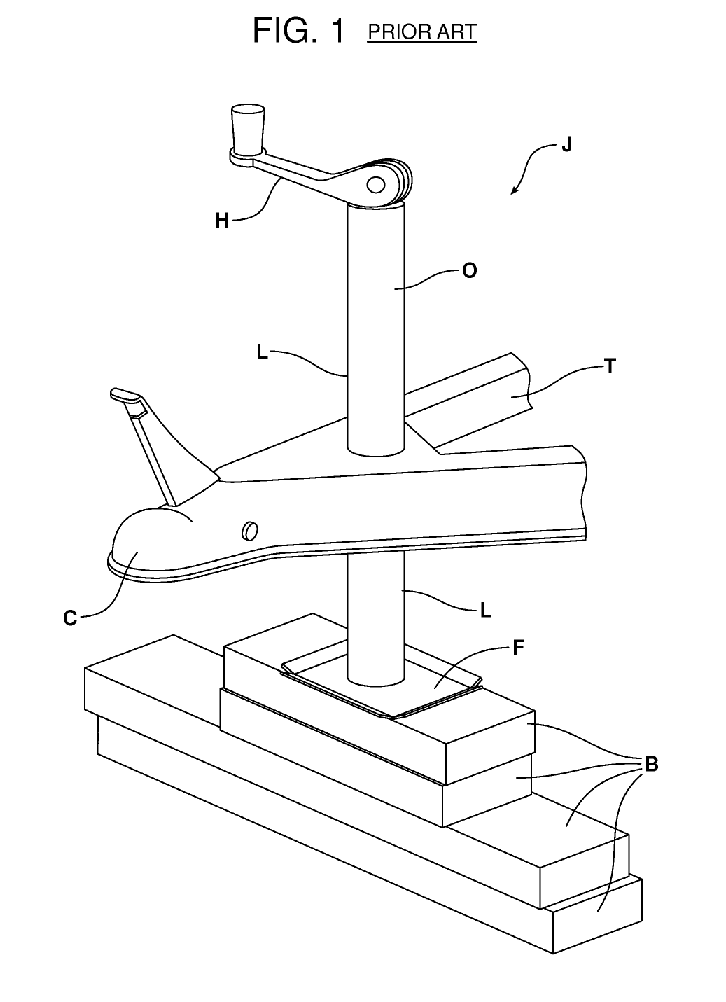

Reference will now be made in detail to the present preferred embodiments of the kit and method, examples of which are illustrated in the accompanying drawing figures.

### DETAILED DESCRIPTION

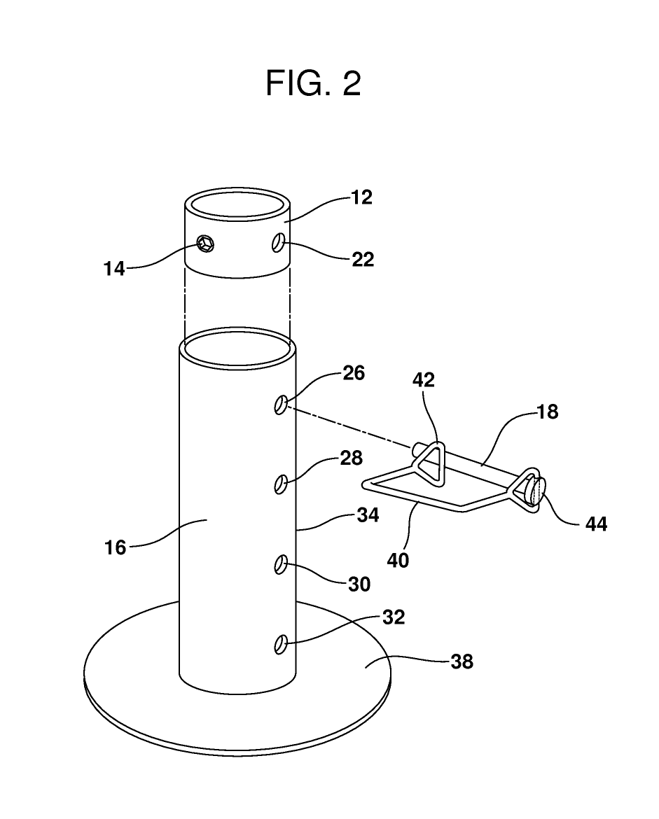

Reference is now made to FIG. 2 illustrating the jack extender kit 10. As illustrated, the kit includes a spacer 12, a first fastener 14, an extension support leg 16 and a second fastener 18.

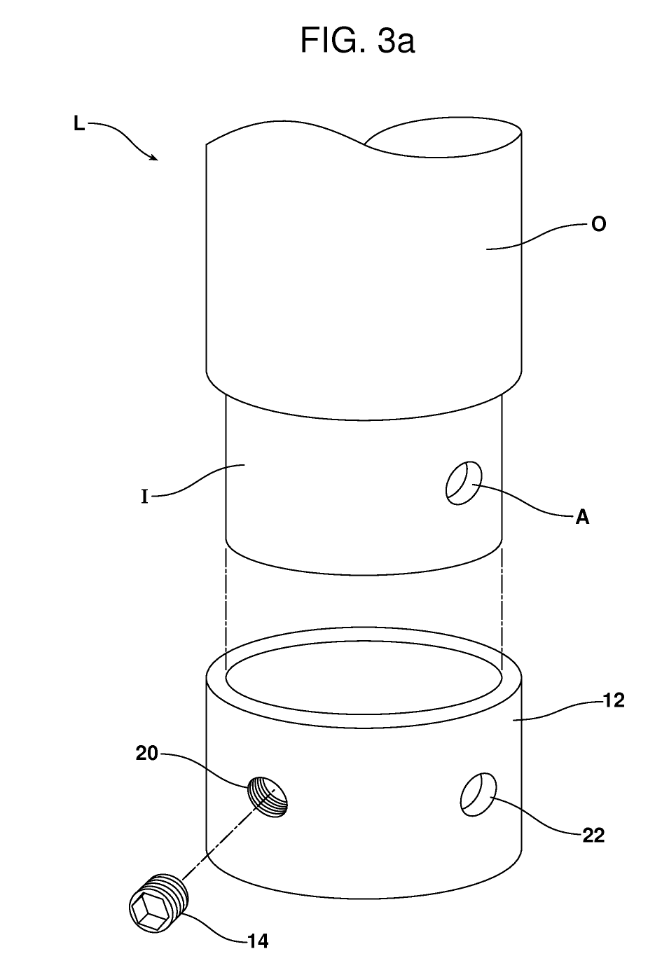

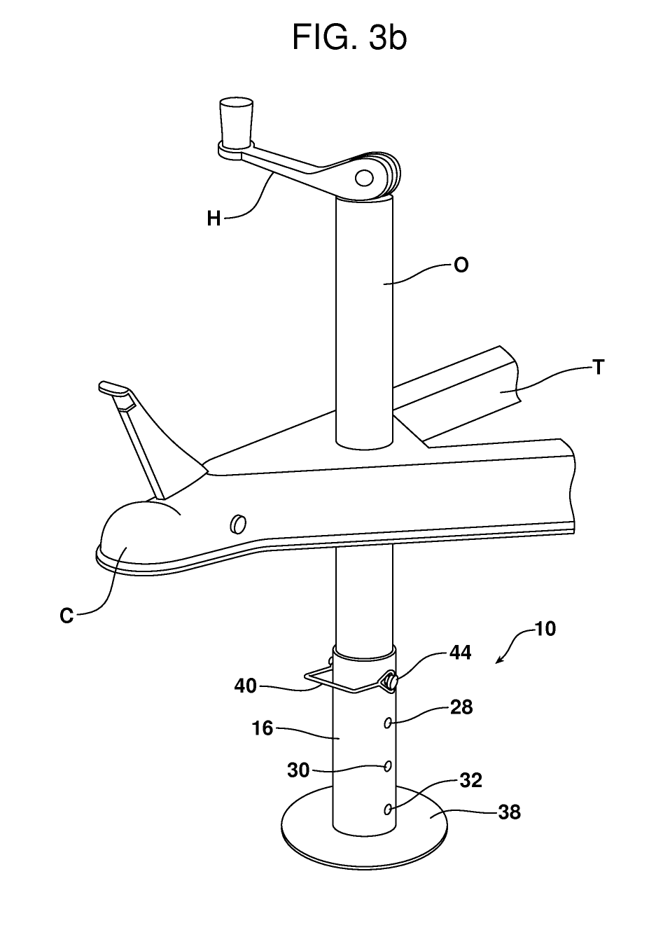

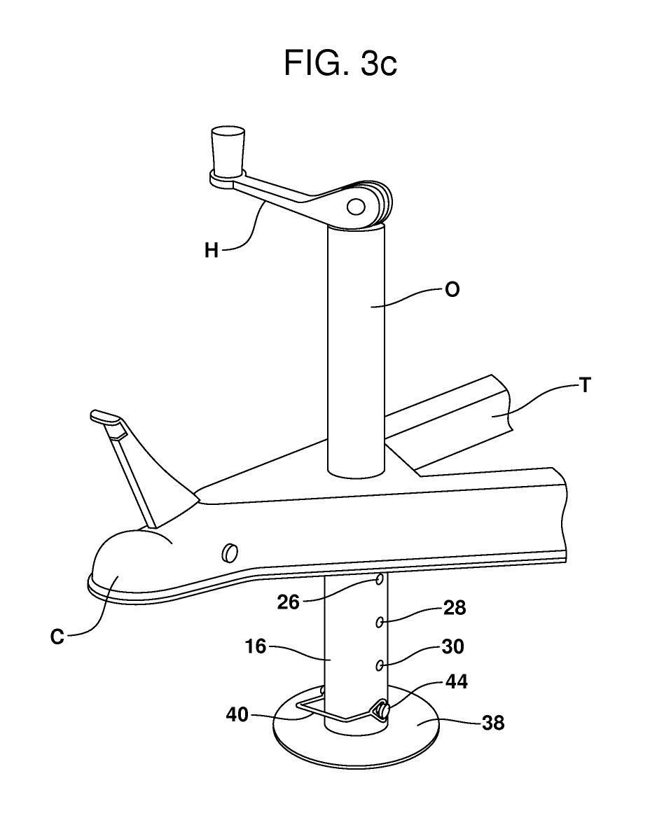

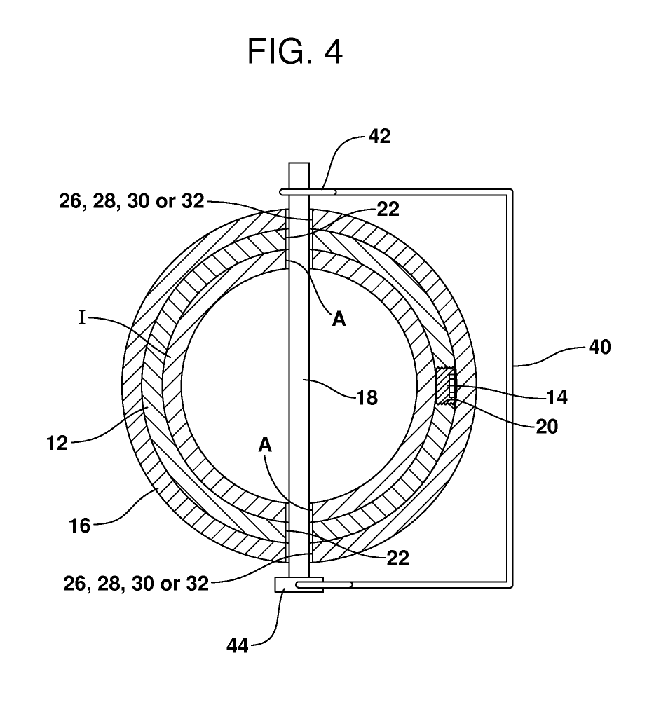

As illustrated, the spacer 12 comprises a sleeve. The inner tube I of the stock support leg L has a first diameter D₁ while the spacer 12 has a second diameter D₂ and the extension support leg or tube 16 has a third diameter D₃ where D₁<D₂<D₃. Accordingly, as illustrated in FIGS. 3a-3c and 4, the spacer may be concentrically received over the inner tube portion I of the stock support leg L, the extension to support leg 16 is concentrically received over the spacer.

More specifically, the spacer 12 includes a first aperture 20 for receiving the first fastener 14 and a first set of opposed mounting apertures 22 adapted for receiving the second fastener 18. In the illustrated embodiment, the first fastener 14 is an Allen screw having a distal end for engaging the sidewall of the inner tube I/stock support leg L and a proximal end contained or confined within the first aperture (see FIG. 4 in cross-section). In this way the fastener/Allen screw 14 does not extend beyond the outer wall of the spacer 12 and interfere with the extension support leg 16 sliding over the spacer. Here it should be noted that the spacer 12 is positioned on the inner tube I so that the first set of opposed mounting apertures 22 are aligned with yet another set of opposed mounting apertures A in the inner tube I. It is these apertures A that are utilized to mount the stock footpad F to the inner tube I of the stock support leg L. That footpad F is removed from the inner tube I by pulling the pin and slipping the foot pad off the inner tube before the spacer 12 is mounted to the end of the inner tube as shown in FIG. 3a.

As further illustrated in FIG. 2, the extension support leg 16 includes four separate second sets of opposed mounting apertures 26, 28, 30, 32 provided in the side wall 34 of the extension support leg 16. These matched sets of opposed apertures 26, 28, 30, 32 are provided at longitudinally spaced locations along the extension support leg 16. As further illustrated, the first or top end 36 of the extension support leg 16 is flared so as to be more easily received over the spacer 12 that is secured on the inner tube I of the stock support leg L. The second or bottom end of the extension support leg 16 includes a trailer support 38. In the illustrated embodiment, that trailer support 38 comprises a foot pad. In other embodiments that support 38 may comprise other structures such as, for example, a wheel assembly (not shown). Further, in some embodiments the trailer support 38 is permanently fixed to the second end of the extension support leg 16. In other embodiments, the trailer support 38 may be attached by means of a clevis pin or other means thereby allowing the operator to choose between different supports such as the footpad and wheel assembly.

As should be appreciated from reviewing FIG. 4, the inner diameter of the spacer 12 is just slightly larger than the outer diameter of the inner tube I while the outer diameter of the spacer 12 substantially equals the outer diameter of the outer tube O of the stock support leg L. In contrast, the inner diameter of the extension support leg 16 is just slightly larger than the outer diameter of both the spacer 12 and the outer tube O thereby allowing enough clearance for the extension support leg 16 to slide relatively easily over the spacer 12 and outer tube O while preventing any substantial free play.

As should be further appreciated, when the extension support leg 16 is positioned overlying the spacer 12 and inner tube I length adjustment is possible. More specifically, as previously noted the extension support leg 16 includes four sets of mounting apertures 26. These sets of opposed mounting apertures 26 are provided at spaced longitudinal locations along the extension support leg 16. When the extension support leg 16 is positioned over the spacer 12, the desired set of opposed mounting apertures 26, 28, 30, 32 is aligned with the mounting apertures 22 in the spacer and the mounting apertures A in the inner tube I and the second fastener 18 is inserted through those aligned mounting apertures in order to complete the connection of the extension support leg 16 to the stock support leg L. In the illustrated embodiment the second fastener 18 is a clevis pin having a cooperating safety clip 40. After inserting the clevis pin 18 into the aligned apertures 26, 28, 30 or 32 and 22 and A, the loop end 42 of the clip 40 opposite the head 44 of the pin is forced over the end of the pin to secure the pin 18 in place.

As illustrated in FIG. 3b, when the first set of opposed mounting apertures 26 in the extension support leg 16 is aligned with the opposed mounting apertures 22 in the spacer 12 and the mounting apertures A in the stock support leg L, the stock support leg L is extended a maximum amount to provide a maximum increase in the height of the trailer jack end of the trailer T. In contrast, as illustrated in FIG. 3c, when the set of opposed mounting apertures 32 in the extension support leg 16 is aligned with the opposed mounting apertures 22 in the spacer 12 and the mounting apertures A in the stock support leg L, the stock support leg is short and effectively standard height. The other intermediate opposed mounting apertures 22, 24 provide length adjustment between the two extremes. In one possible embodiment, these sets of opposed mounting apertures 26, 28, 30, 32 provided in the extension support leg 16 are spaced approximately 2 inches apart thereby providing telescoping trailer height adjustment in 2 in. graduations.

As should be appreciated from the previous description and the illustrations in FIGS. 3a-3c and 4, the kit 10 functions to provide a method of adjusting the height of a trailer jack J and, effectively, the height of a trailer jack end of the trailer T to which the jack is connected. That method may be broadly described as comprising the steps of: (a) positioning a spacer sleeve 12 over an inner tube I of a stock trailer support leg L/stock trailer jack J, (b) positioning an extension support leg 16 over the spacer sleeve on the stock trailer leg and (c) securing an extension support leg to the inner tube of the stock trailer jack. Further the method includes adjusting the positioning of the extension support leg 16 on the inner tube I of the stock trailer jack J to telescopingly adjust the length of the stock trailer jack support leg L and the height of the trailer jack end of the trailer T.

The foregoing has been presented for purposes of illustration and description. It is not intended to be exhaustive or to limit the embodiments to the precise form disclosed. Obvious modifications and variations are possible in light of the above teachings. For example, while the illustrated embodiment includes an extension support leg 16 having four sets of opposed mounting apertures 20, 26, 28, 30, 32 allowing telescoping length/height adjustment of four different graduations, fewer or additional opposed mounting apertures may be provided as desired. Further, while the first fastener 14 in the illustrated embodiment is an Allen screw, other types of fasteners may be utilized. In addition, while the second fastener 18 in the illustrated embodiment is a clevis pin, other types of fasteners may be utilized so long as they are suited for the intended purpose. All such modifications and variations are within the scope of the appended claims when interpreted in accordance with the breadth to which they are fairly, legally and equitably entitled.

What is claimed:

1. A kit for extending a stock support leg of a trailer jack, comprising:
a spacer received over a portion of the stock support leg; and
an extension support leg received over said spacer.

2. The kit of claim 1, wherein said spacer is a sleeve and said portion of said stock support leg has a first diameter D₁, said spacer has a second diameter of D₂ and said extension support leg has a third diameter D₃ where D₁<D₂<D₃ and whereby said spacer is concentrically received over said portion of said stock support leg and said extension tube is concentrically received over said spacer.

3. The kit of claim 2, further including a first fastener securing said spacer to said stock support leg and a second fastener securing said extension support leg to said stock support leg.

4. The kit of claim 3, wherein said spacer includes a first aperture receiving said first fastener and a first set of opposed mounting apertures receiving said second fastener.

5. The kit of claim 4, wherein said first fastener is an Allen screw having a distal end engaging said stock support leg and a proximal end contained within said first aperture.

6. The kit of claim 5, wherein said extension support leg includes a second set of opposed mounting apertures aligned with (a) said first set of opposed mounting apertures in said spacer and (b) a third set of opposed mounting apertures in said stock support leg.

7. The kit of claim 6, wherein said second fastener extends through said first, second and third set of opposed mounting apertures.

8. The kit of claim 7, wherein said second fastener is a clevis pin.

9. The kit of claim 8, wherein said extension support leg includes a plurality of second sets of opposed mounting apertures spaced longitudinally along said extension support leg so as to allow for different positioning on said stock support leg and height adjustment of the trailer jack.

10. The kit of claim 9, wherein said extension support leg is flared at a first end so as to be more easily received over said spacer and said stock support leg.

11. The kit of claim 10, further including a trailer support at a second end of said extension support leg.

12. The kit of claim 11, wherein said trailer support in a foot pad.

13. A method of adjusting height of a trailer jack, comprising:
positioning a spacer sleeve over an inner tube of a stock trailer jack;
positioning an extension support leg over said spacer sleeve on said stock trailer leg; and
securing the extension support leg to the inner tube of the stock trailer jack.

14. The method of claim 13, further including adjusting positioning of said extension support leg on said inner tube of said stock trailer jack in order to adjust the height of said stock trailer jack.
